(19) United States
(12) Patent Application Publication
(10) Pub. No.: US 2026/0285291 A1
(43) Pub. Date: Sep. 24, 2026

(54) CONTROL DEVICE FOR VEHICLE

(71) Applicant: TOYOTA JIDOSHA KABUSHIKI KAISHA, Toyota-shi (JP)

(72) Inventors: Yoshikazu ASAMI, Gotemba-shi (JP); Nobuo Yagihashi, Miyoshi-shi (JP); Takamitsu Mizutani, Toyota-shi (JP); Yuki Morita, Toyota-shi (JP)

(73) Assignee: TOYOTA JIDOSHA KABUSHIKI KAISHA, Toyota-shi (JP)

(21) Appl. No.: 19/449,724

(22) Filed: Jan. 15, 2026

(30) Foreign Application Priority Data
Mar. 24, 2025 (JP) 2025-048379

(51) Int. Cl. B60W 20/16; B60W 10/06; B60W 10/08; B60W 10/26; B60W 30/192; F02D 41/00; F02D 41/02; F02P 5/04; F02P 5/15

(52) U.S. Cl. CPC B60W 20/16; B60W 10/06; B60W 10/08; B60W 10/26; B60W 30/192; F02D 41/0002; F02D 41/0255; F02P 5/045; F02P 5/1504; B60W 2510/244; B60W 2710/0633; B60W 2710/0694; B60W 2710/08; B60W 2710/244

(57) ABSTRACT

A control device performs a catalyst warm-up control of retarding an ignition timing and increasing an intake air amount of an internal combustion engine to warm up a catalyst in a case where a warm-up request for the catalyst is present at engine start. The processing circuit included in the control device is configured to execute determination processing of determining whether polarization is likely to occur in a battery in a case where a warm-up request for a catalyst is present, and change processing of increasing, in a case where determination is made that the polarization is likely to occur in the determination processing, both a retardation amount of an ignition timing and an amount of increment in an intake air amount in a catalyst warm-up control, as compared with a case where determination is made that the polarization is unlikely to occur.

### CROSS-REFERENCE TO RELATED APPLICATION

This application claims priority to Japanese Patent Application No. 2025-048379 filed on Mar. 24, 2025. The disclosure of the above-identified application, including the specification, drawings, and claims, is incorporated by reference herein in its entirety.

### BACKGROUND

### 1. Technical Field

The present disclosure relates to a control device for a vehicle.

### 2. Description of Related Art

For example, Japanese Unexamined Patent Application Publication No. 2013-133040 (JP 2013-133040 A) discloses a hybrid vehicle including, as prime movers, an internal combustion engine including a catalyst for exhaust gas cleaning and an electric motor that is supplied with power from a battery. In such a vehicle, a temperature of the catalyst is lowered during EV traveling in which the vehicle travels using solely an output of the electric motor. Therefore, in a case where the engine is started during the EV traveling, a catalyst warm-up control of raising the temperature of the catalyst is executed. In the catalyst warm-up control, for example, an ignition timing is retarded and the intake air amount is increased to raise the temperature of the exhaust gas, so that the catalyst is warmed up early.

### SUMMARY

In a case where EV traveling is continuously performed for a long time, discharge from a battery is also continuously performed for a long time. It is known that, in a case where the discharge from the battery is continuously performed for a long time, polarization occurs in the battery, and an electromotive force is lowered. In a case where the electromotive force of the battery is lowered, a power supplied to the electric motor is

lowered, so that an output of the electric motor is lowered. In a case where the output of the electric motor is lowered as described above, an output of an internal combustion engine is increased to compensate for an output needed for traveling. In a case where the catalyst is in an insufficiently warmed-up state when the output of the internal combustion engine is increased, exhaust gas increased with the increment in the output of the internal combustion engine cannot be appropriately cleaned. Therefore, emissions may be deteriorated.

A control device for a vehicle that solves a problem described above is applied to a vehicle including, as prime movers, an internal combustion engine including a catalyst for exhaust gas cleaning in an exhaust passage and an electric motor supplied with power from a battery. The control device performs, when a warm-up request for the catalyst is present at engine start, catalyst warm-up control of retarding an ignition timing and increasing an intake air amount of the internal combustion engine to warm up the catalyst. The control device includes a processing circuit.

The processing circuit is configured to execute:

determining, when the warm-up request is present, whether polarization is likely to occur in the battery; and

changing in which, in a case where determination is made that the polarization is likely to occur in the determination processing, both a retardation amount of the ignition timing and an amount of increment in the intake air amount in the catalyst warm-up control are increased, as compared with a case where determination is made that the polarization is unlikely to occur.

The control device for a vehicle can suppress the deterioration of emissions.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a configuration of a vehicle according to an embodiment;

FIG. 2 is a flowchart showing a procedure of processing executed by the processing circuit of the embodiment;

FIG. 3 is a diagram showing a relationship between a second retardation amount and an EV traveling distance in the embodiment;

FIG. 4 is a diagram showing a relationship between a second air amount and the EV traveling distance in the embodiment; and

FIG. 5 is a timing chart showing an operation of the embodiment, and shows a transition of the following values or times from the upper chart: an accelerator operation amount, a traveling request output, a requested engine output, an engine rotational speed, an engine torque, an intake air amount, an ignition timing, and an HC emission amount.

### DETAILED DESCRIPTION OF EMBODIMENTS

### Configuration of Vehicle

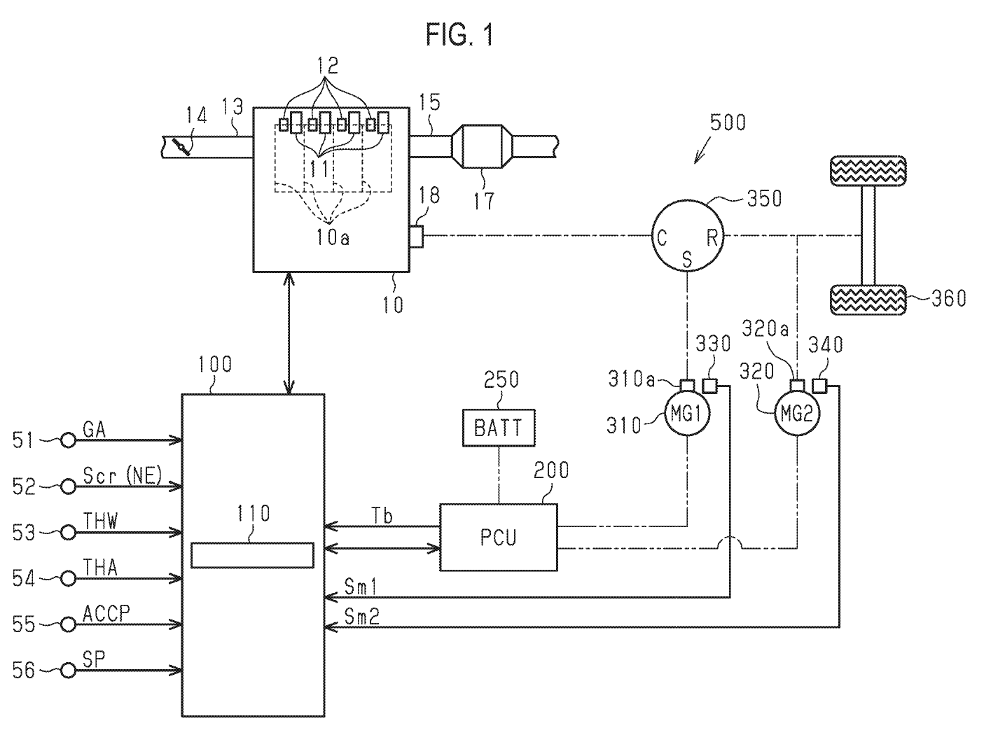

Hereinafter, an embodiment in which the control device for a vehicle is specified will be described. As shown in FIG. 1, a vehicle 500 is a hybrid electric vehicle including an internal combustion engine 10 and an electric motor as prime movers.

The internal combustion engine 10 includes a plurality of cylinders 10a. An intake passage 13 is connected to an intake port of each of the cylinders 10a. A throttle valve 14 that adjusts the intake air amount is provided in the intake passage 13.

A fuel injection valve 11 is disposed in a combustion chamber of each of the cylinders 10a. In the combustion chamber of each of the cylinders 10a, the air-fuel mixture of the air sucked through the intake passage 13 and the fuel injected from the fuel injection valve 11 is combusted by being ignited by spark discharge of an ignition plug 12. Exhaust gas generated by combustion of the air-fuel mixture in the combustion chamber is discharged to an exhaust passage 15 connected to an exhaust port of the internal combustion engine 10.

A catalyst 17 for exhaust gas cleaning is provided in the exhaust passage 15. The catalyst 17 is a three-way catalyst. The catalyst 17 oxidizes hydrocarbons (HC) or carbon monoxide (CO) contained in the exhaust gas to generate water or carbon dioxide. In addition, the catalyst 17 reduces nitrogen oxides (NOx) contained in the exhaust gas to generate nitrogen.

A crankshaft 18 of the internal combustion engine 10 is mechanically connected to a carrier C of a planetary gear mechanism 350 constituting a power split device.

The carrier C holds rotation shafts of a plurality of pinion gears provided in the planetary gear mechanism 350.

A rotation shaft 310a of a first motor generator (hereinafter, referred to as a first MG) 310 that is an electric motor is mechanically connected to a sun gear S of the planetary gear mechanism 350.

In addition, a rotation shaft 320a of a second motor generator (hereinafter, referred to as a second MG) 320 that is an electric motor and a drive wheel 360 are mechanically connected to a ring gear R of the planetary gear mechanism 350.

The first MG 310 functions as a generator that generates power using the engine output, and functions as a starter for cranking the crankshaft 18 during starting of the internal combustion engine 10.

The second MG 320 functions as an electric motor that generates a drive force of the drive wheel 360, and functions as a generator that generates power by regenerative braking during deceleration of the vehicle 500. In a case where the second MG 320 generates power by regenerative braking, a regenerative braking force that is a braking force by the regenerative braking is generated in the second MG 320.

Both the first MG 310 and the second MG 320 exchange power with a battery 250 via a power control unit (PCU) 200. The battery 250 is charged using the output of the internal combustion engine 10 and supplies power to the first MG 310 and the second MG 320. The PCU 200 includes a converter that boosts and outputs a direct current voltage input from the battery 250, an inverter that converts the direct current voltage boosted by the converter into an alternating current voltage and outputs the alternating current voltage to each of the MGs 310 and 320, and the like. The PCU 200 outputs a battery temperature Tb that is a temperature of the battery 250 to the outside.

### Regarding Control Device

A control device 100 controls the output or exhaust characteristics of the internal combustion engine 10 by controlling the intake air amount, the fuel injection amount, and the ignition timing. In addition, the control device 100 operates the inverter via the PCU 200 to control the torque of the first MG 310. In addition, the control device 100 operates the inverter via the PCU 200 to control the torque of the second MG 320. In addition, the magnitude of the regenerative braking force of the second MG 320 is changed by operating the inverter via the PCU 200. The larger the power generated by the second MG 320, the larger the regenerative braking force and the larger the deceleration of the vehicle 500 by the regenerative braking force.

The control device 100 includes a processing circuit 110. The processing circuit 110 includes a CPU that executes various types of processing in accordance with a program, and a ROM that stores various types of programs.

The control device 100 refers to detection values of various sensors. For example, the control device 100 refers to a detection value of an air flowmeter 51 that detects the intake air amount GA of the internal combustion engine 10. The control device 100 refers to a detection signal Scr of a crank angle sensor 52 that detects a rotation angle of the crankshaft 18. The control device 100 refers to a detection value of a water temperature sensor 53 that detects a coolant temperature THW that is a temperature of coolant of the internal combustion engine 10. The control device 100 refers to a detection value of an intake air temperature sensor 54 that detects an intake air temperature THA that is a temperature of intake air of the internal combustion engine 10. The control device 100 refers to a detection signal of an accelerator position sensor 55 that detects an accelerator operation amount ACCP that is an operation amount of an accelerator pedal operated by a driver of the vehicle 500. The control device 100 refers to a detection signal of a speed sensor 56 that detects a vehicle speed SP of the vehicle 500. The control device 100 refers to an output signal Sm1 of a first rotation angle sensor 330 that detects a rotation angle of the first MG 310 and an output signal Sm2 of a second rotation angle sensor 340 that detects a rotation angle of the second MG 320. The control device 100 acquires the battery temperature Tb that is a temperature of the battery 250 from the PCU 200.

The control device 100 calculates the engine rotational speed NE based on the detection signal Scr of the crank angle sensor 52. In addition, the control device 100 calculates the engine load rate KL based on the engine rotational speed NE and the intake air amount GA. The engine load rate KL represents a ratio of the current cylinder inflow air amount to a cylinder inflow air amount in a case where the internal combustion engine 10 is continuously operated at the current engine rotational speed NE in a full load state. The cylinder inflow air amount is an amount of air flowing into each of the cylinders in an intake stroke.

The control device 100 calculates a traveling request output P needed for traveling of the vehicle based on the accelerator operation amount ACCP and the vehicle speed SP. The control device 100 controls the requested engine output Pe of the internal combustion engine 10 or the requested output of the first motor generator 310 and the second motor generator 320 such that the traveling request output P is satisfied. For example, in a case where the requested engine output Pe is "0", the control device 100 stops the operation of the internal combustion engine 10 and performs EV traveling in which the vehicle travels using solely the output of the second motor generator 320. In addition, in a case where the requested engine output Pe is larger than "0", the control device 100 operates the internal combustion engine 10 to obtain the engine output and performs hybrid traveling in which the vehicle travels using the engine output and the output of the second motor generator 320.

### Regarding Catalyst Warm-up Control

The control device 100 performs a catalyst warm-up control of retarding the ignition timing and increasing the intake air amount of the internal combustion engine 10 to warm up the catalyst 17 in a case where a warm-up request for the catalyst 17 is present at engine start.

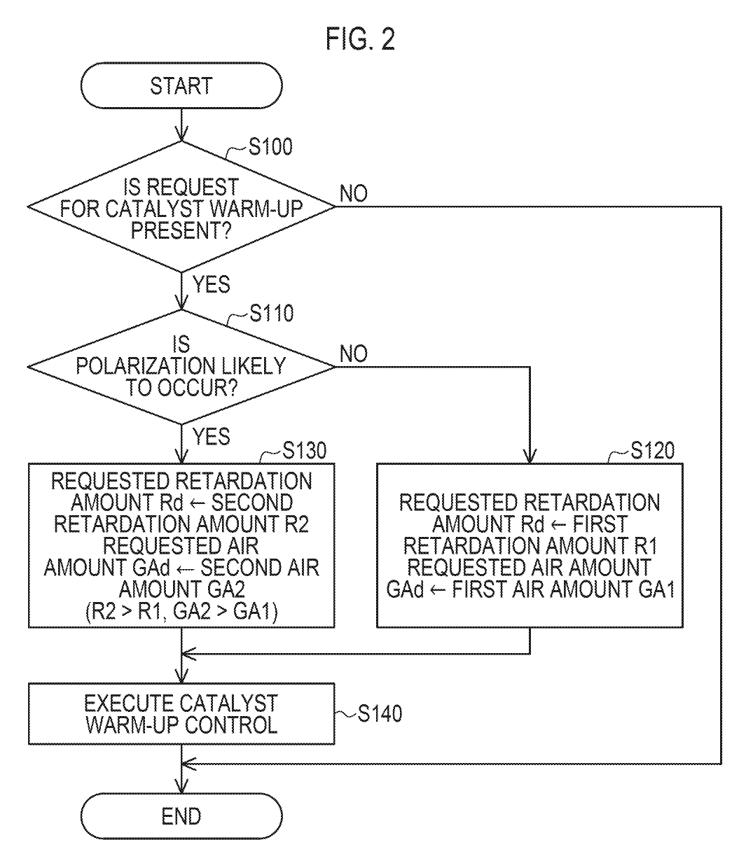

FIG. 2 shows a procedure of processing executed by the processing circuit 110 of the control device 100. The present processing is started to be executed at engine start. Further, in the following, each of step numbers of the process is represented by a number prefixed with “S.”

In a series of processing shown in FIG. 2, the processing circuit 110 first determines whether there is a warm-up request for the catalyst 17 (S100). The determination in the processing of S100 can be appropriately performed. For example, in a case where the coolant temperature THW at engine start is equal to or lower than a predetermined value, the processing circuit 110 may determine that there is a warm-up request for the catalyst 17. In addition, in a case where the temperature of the catalyst 17 at engine start is equal to or lower than a predetermined value, the processing circuit 110 may determine that there is a warm-up request for the catalyst 17. In addition, in the first start after the soak, the processing circuit 110 may determine that there is a warm-up request for the catalyst 17.

In the processing of S100, in a case where it is determined that there is a warm-up request for the catalyst 17 (S100: YES), the processing circuit 110 executes determination processing of determining whether the polarization is likely to occur in the battery 250 (S110). Here, the polarization of the battery 250 is more likely to occur as the continuous traveling distance of the EV traveling (hereinafter, referred to as an EV traveling distance) increases, and thus the continuous discharge time of the battery 250 increases. Therefore, in the processing of S110, the processing circuit 110 determines that the polarization is likely to occur in a case where the EV traveling distance is equal to or larger than a predetermined value. On the other hand, in a case where the EV traveling distance is smaller than the predetermined value, the processing circuit 110 determines that the polarization is unlikely to occur.

In the processing of S110, in a case where it is determined that the polarization is unlikely to occur (S110: NO), the processing circuit 110 performs the following processing. That is, the processing circuit 110 executes processing of substituting the first retardation amount R1 into the requested retardation amount Rd and substituting the first air amount GA1 into the requested air amount GAd (S120). The requested retardation amount Rd is a retardation amount of the ignition timing for executing the catalyst warm-up control, and the first retardation amount R1 is a predetermined suitable value. The requested air amount GAd is an intake air amount for executing the catalyst warm-up control, and the first air amount GA1 is a predetermined suitable value. An amount larger than the intake air amount in a case where the catalyst warm-up control is not executed is set as the first air amount GA1. Therefore, the intake air amount GA is increased in a case where the catalyst warm-up control is started.

On the other hand, in the processing of S110, in a case where it is determined that the polarization is likely to occur (S110: YES), the processing circuit 110 performs the following processing. That is, the processing circuit 110 executes processing of substituting the second retardation amount R2 into the requested retardation amount Rd and substituting the second air amount GA2 into the requested air amount GAd (S130). The second retardation amount R2 is a value larger than the first retardation amount R1. The second air amount GA2 is a value larger than the first air amount GA1. The processing of S130 corresponds to change processing. The change processing is processing of increasing both the retardation amount of the ignition timing and the amount of increment in the intake air amount in the catalyst warm-up control, in a case where it is determined in the determination processing that the polarization is likely to occur, as compared with a case where it is determined that the polarization is unlikely to occur.

Here, the EV traveling distance and the continuous discharge time of the battery 250 are correlation values that are correlated with the degree of decrease in the electromotive force of the battery 250 due to the polarization. That is, as the EV traveling distance increases and the continuous discharge time increases, the electromotive force is likely to decrease more in a case where the polarization occurs. Therefore, in the processing of S130, the processing circuit 110 acquires the EV traveling distance that is the correlation value. The processing circuit 110 variably sets the second retardation amount R2 and the second air amount GA2 based on the acquired EV traveling distance. With this configuration, the catalyst can be warmed up earlier as the decrease in the electromotive force is larger, that is, as the requested engine output Pe is larger.

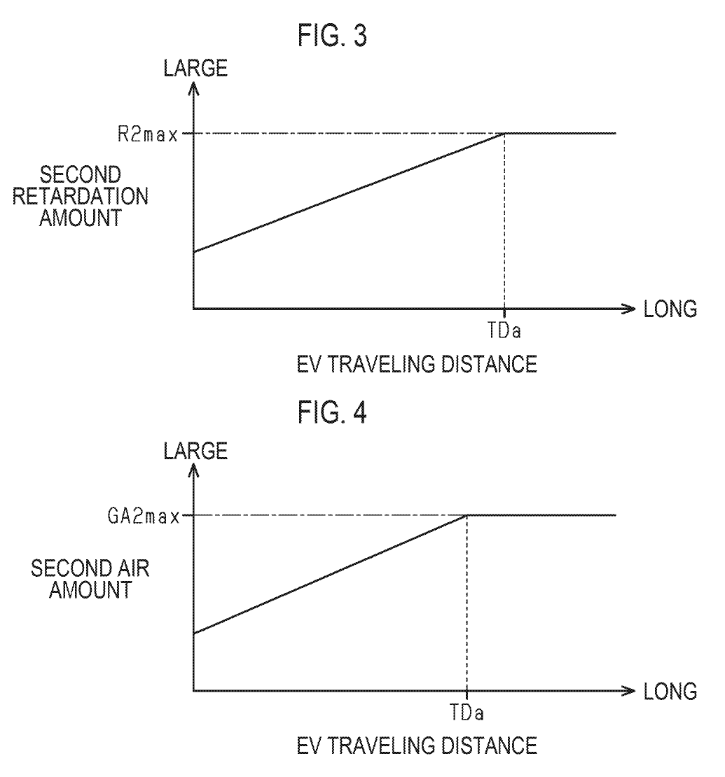

As shown in FIG. 3, the second retardation amount R2 is variably set such that the value is larger as the EV traveling distance is longer. In a case where the EV traveling distance is equal to or longer than a predetermined distance TDa, the second retardation amount R2 is fixed to a maximum value R2max.

As shown in FIG. 4, the second air amount GA2 is variably set such that the value is larger as the EV traveling distance is longer. In a case where the EV traveling distance is equal to or longer than a predetermined distance TDa, the second air amount GA2 is fixed to a maximum value GA2max.

In a case where the processing of S120 or the processing of S130 is executed, the processing circuit 110 executes the catalyst warm-up control (S140). In the catalyst warm-up control of S140, the ignition timing is controlled such that the requested retardation amount Rd is obtained, and the opening of the throttle valve 14 is controlled such that the requested air amount GAd is obtained.

### Operation of Present Embodiment

In a case where the processing of S140 is completed or a negative determination is made in the processing of S100, the processing circuit 110 ends the present processing.

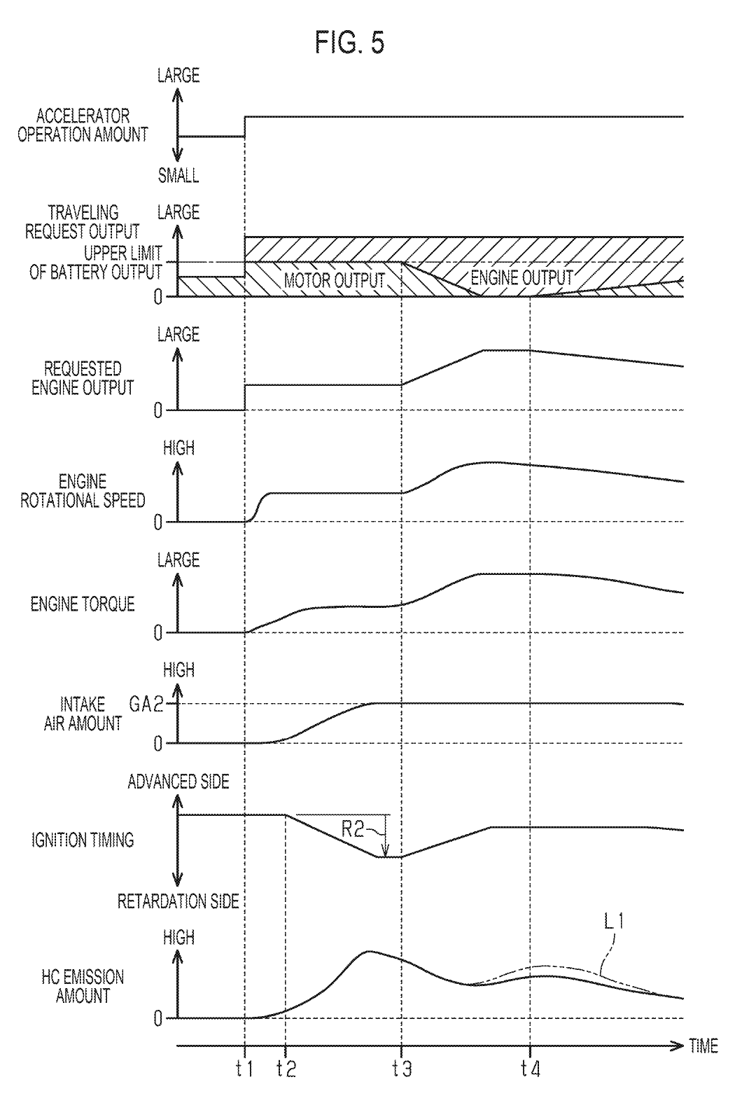

FIG. 5 shows an operation of the present embodiment in a case where the request for the catalyst warm-up is made and it is determined that the polarization is likely to occur. The timing chart of FIG. 5 shows a transition of the following values or times from the top: an accelerator operation amount, a traveling request output, a requested engine output, an engine rotational speed, an engine torque, an intake air amount, an ignition timing, and an HC emission amount discharged from the exhaust passage.

EV traveling is performed before time t1. In a case where the accelerator operation amount ACCP is increased at time t1, the traveling request output P increases. In a case where the traveling request output P exceeds an upper limit of the battery output that can be supplied to the second MG 320, that is, an upper limit of the output of the second MG 320, the requested engine output Pe for compensating for the insufficiency of the output is calculated, and the engine is started. As a result, the engine rotational speed, the engine torque, and the HC emission amount are increased. In addition, the intake air amount GA is gradually increased toward the second air amount GA2. In addition, after time t2 at which a predetermined time has elapsed from the start of the engine, the ignition timing is gradually retarded toward the second retardation amount R2. The catalyst is warmed up early by the increment in the intake air amount GA and the retardation of the ignition timing.

In a case where the polarization occurs in the battery 250 at time t3, the motor output of the second MG 320 gradually decreases. In order to compensate for the decrease in the motor output, the requested engine output Pe is increased. In a case where the output increment request for the internal combustion engine 10 occurs during the execution of the catalyst warm-up control in this way, the processing circuit 110 executes processing of reducing the retardation amount of the ignition timing. As a result, the ignition timing is shifted to the advanced side in a state where the intake air amount is increased by the catalyst warm-up control, so that the engine output is quickly increased.

In a case where the catalyst 17 is not warmed up and the catalyst 17 is in an insufficiently warmed-up state at the time of the increment in the requested engine output Pe, the HC emission amount may increase as indicated by a two-dot chain line L1. In this regard, in the present embodiment, the second retardation amount R2 and the second air amount GA2 are set in the catalyst warm-up control. Therefore, both the retardation amount of the ignition timing and the amount of increment in the intake air amount in the catalyst warm-up control are larger than those in a case where the first retardation amount R1 and the first air amount GA1 are set. Therefore, the catalyst 17 is quickly warmed up. Therefore, the increase in the HC emission amount due to the increase in the requested engine output Pe for compensating for the decrease in the motor output is suppressed by the cleaning action of the catalyst 17.

In a case where the polarization in the battery 250 is eliminated at time t4, the motor output of the second MG 320 gradually increases. As the motor output increases, the requested engine output Pe gradually decreases, so that the ratio of the engine output to the traveling request output gradually decreases.

### Effects of Present Embodiment

(1) The control device 100 performs the catalyst warm-up control of retarding the ignition timing and increasing the intake air amount of the internal combustion engine 10 to warm up the catalyst 17 in a case where the warm-up request for the catalyst 17 is present at engine start. The processing circuit 110 executes the determination processing of determining whether the polarization is likely to occur in the battery 250 in a case where the warm-up request for the catalyst 17 is present. The processing circuit 110 executes the change processing in a case where it is determined that the polarization is likely to occur in the determination processing. The change processing is processing of increasing both the retardation amount of the ignition timing and the amount of increment in the intake air amount in the catalyst warm-up control, in a case where it is determined that the polarization is likely to occur in the determination processing, as compared with a case where it is determined that the polarization is unlikely to occur.

Therefore, in a case where the polarization is likely to occur in the battery 250, both the retardation amount of the ignition timing and the amount of increment in the intake air amount in the catalyst warm-up control are large, so that the catalyst 17 is quickly warmed up. Therefore, the catalyst 17 is likely to be warmed up before the polarization occurs. Therefore, in a case where the decrease in the output of the second MG 320 due to the polarization is compensated for by the increment in the output of the internal combustion engine 10, the exhaust gas that increases with the increment in the output of the internal combustion engine 10 is appropriately cleaned by the catalyst 17. Therefore, the deterioration of emissions is suppressed.

(2) In the change processing, a correlation value that is correlated with the degree of decrease in the electromotive force of the battery 250 due to the polarization is acquired. The correlation value is a continuous traveling distance of the EV traveling in which the vehicle travels using solely the output of the second MG 320. The retardation amount of the ignition timing and the amount of increment in the intake air amount are variably set based on the correlation value.

Therefore, the retardation amount of the ignition timing and the amount of increment in the intake air amount in the catalyst warm-up control can be set according to the degree of decrease in the electromotive force of the battery 250 due to the polarization.

(3) The processing circuit 110 executes processing of reducing the retardation amount of the ignition timing in a case where the output increment request for the internal combustion engine 10 occurs during the execution of the catalyst warm-up control. As a result, in a case where the output increment request for the internal combustion engine 10 occurs during the execution of the catalyst warm-up control, the ignition timing is advanced. Therefore, the ignition timing is shifted to the advanced side in a state where the intake air amount is increased by the catalyst warm-up control, so that the engine output is quickly increased. Therefore, the responsiveness of the increment in the output of the internal combustion engine 10 can be improved.

### Modification

The present embodiment described above can be modified and carried out as follows. The present embodiment described above and the following modifications can be carried out in combination within a technically consistent range.

In the processing of S110 shown in FIG. 2, the determination of whether the polarization is likely to occur is made based on the EV traveling distance, but the determination may be made based on other values. For example, the determination may be made based on the continuous discharge time of the battery 250 or the voltage of the battery 250.

In the processing of S130 shown in FIG. 2, the second retardation amount R2 is set based on the EV traveling distance, but the second retardation amount R2 may be set based on other values. For example, setting may be performed based on the continuous discharge time of the battery 250 or the voltage of the battery 250.

In the processing of S130 shown in FIG. 2, the second air amount GA2 is set based on the EV traveling distance, but the second air amount GA2 may be set based on other values. For example, setting may be performed based on the continuous discharge time of the battery 250 or the voltage of the battery 250.

In the processing of S130 shown in FIG. 2, the second retardation amount R2 is variably set based on the EV traveling distance, but a fixed value that is prepared in advance may be set as the second retardation amount R2.

In the processing of S130 shown in FIG. 2, the second air amount GA2 is variably set based on the EV traveling distance, but a fixed value that is prepared in advance may be set as the second air amount GA2.

The hybrid system of the vehicle 500 is not limited to that shown in FIG. 1, and may be another hybrid system.

The number of motor generators provided in the vehicle 500 can be appropriately changed.

The control device 100 is not limited to one that includes a CPU and a memory to execute software processing. For example, the control device 100 may include a dedicated hardware circuit such as an application-specific integrated circuit (ASIC) that performs hardware processing on at least a part of what has been software-processed in the embodiment. That is, the control device 100 may include a processing circuit including any configuration of the following (a) to (c). (a) a processing circuit including one or more processing devices that execute all of the processing in accordance with a program, and one or more program storage devices that store the program, such as a ROM. (b) a processing circuit including one or more processing devices and one or more program storage devices that execute a part of the processing in accordance with a program, and one or more dedicated hardware circuits that execute the remaining processing. (c) a processing circuit including one or more dedicated hardware circuits that execute all of the processing. The program storage device, that is, the computer-readable medium includes any available medium that can be accessed by a general-purpose or dedicated computer.

What is claimed is:

1. A control device for a vehicle including, as prime movers, an internal combustion engine including a catalyst for exhaust gas cleaning in an exhaust passage and an electric motor supplied with power from a battery, the control device being applied to the vehicle and performing, when a warm-up request for the catalyst is present at engine start, catalyst warm-up control of retarding an ignition timing and increasing an intake air amount of the internal combustion engine to warm up the catalyst, the control device comprising a processing circuit, wherein the processing circuit is configured to execute:
determining, when the warm-up request is present, whether polarization is likely to occur in the battery; and
changing in which, in a case where determination is made that the polarization is likely to occur in the determining, both a retardation amount of the ignition timing and an amount of increment in the intake air amount in the catalyst warm-up control are increased, as compared with a case where determination is made that the polarization is unlikely to occur.

2. The control device according to claim 1, wherein, in the changing, a correlation value indicative of a degree of decrease in an electromotive force of the battery due to the polarization is acquired, and the retardation amount of the ignition timing and the amount of increment in the intake air amount are variably set based on the correlation value.

3. The control device according to claim 2, wherein the correlation value is a continuous traveling distance of EV traveling in which the vehicle travels using an output of the electric motor.

4. The control device according to claim 2, wherein the correlation value is a continuous discharge time of the battery.

5. The control device according to claim 1, wherein the processing circuit is configured to execute reducing the retardation amount of the ignition timing in a case where an output increment request for the internal combustion engine occurs during execution of the catalyst warm-up control.
